(19) United States
(12) Patent Application Publication
(10) Pub. No.: US 2004/0221324 A1
(43) Pub. Date: Nov. 4, 2004

(54) Digital television having a modular programmable conditional access system

(75) Inventors: Ahmad C. Ansari, Austin, TX (US); David B. Hartman, Austin, TX (US)

Correspondence Address: TOLER & LARSON & ABEL L.L.P., 5000 PLAZA ON THE LAKE STE 265, AUSTIN, TX, 78746, US

(73) Assignee: SBC, Inc.

(21) Appl. No.: 10/607,813

(22) Filed: Jun. 27, 2003

Related U.S. Application Data
(63) Continuation-in-part of application No. 10/427,704, filed on Apr. 30, 2003.

(51) Int. Cl. H04N 7/16

(52) U.S. Cl. 725/140; 725/70

(57) ABSTRACT

A digital display monitor module (DDMM) has a display device to display video provided thereto. An interactive network module (INM) removably interfaces with the DDMM to provide the video signals to the DDMM. The INM comprises an input interface and a programmable conditional access system (PCAS) to enable conditional access to at least one premium television service received by the input interface. The PCAS is programmable by at least two different service providers.

### CROSS REFERENCE TO RELATED APPLICATIONS

The present application is a continuation-in-part of “MULTI-PLATFORM DIGITAL TELEVISION”, U.S. patent application Ser. No. 10/427,706, filed Apr. 30, 2003, having Attorney Docket No. T00504, pending, whose contents are hereby incorporated by reference herein.

### FIELD OF THE DISCLOSURE

The present disclosure relates to digital television sets.

### DESCRIPTION OF THE RELATED ART

Migration to digital television (DTV) is a major milestone in the development of broadcast and entertainment video services. Broadcasters, network service providers and consumer electronics companies are faced with challenges and mandated deadlines to successfully achieve this migration.

The consumer electronics industry is looking at integrated digital television (IDTV) sets that would have built-in demodulation and Motion Picture Experts Group (MPEG)-2 decompression chip sets. The MPEG-2 compression standard is an adopted standard for compressing DTV content which encompasses both standard definition television (SDTV) and high definition television (HDTV) content.

Recently, a new compression standard, known as H.264 AVC, has emerged. The H.264 AVC standard, which offers higher quality video at lower bit rates, may significantly reduce bandwidth requirements for entertainment video services. An IDTV set whose design is based on MPEG-2 compression would be difficult to upgrade to more advanced compression technologies such as H.264 AVC, for example.

Present delivery networks of entertainment video services include broadcast delivery networks and multicast delivery networks. Examples of delivery networks include off-air, satellite, cable, hybrid fiber coax (HFC), fiber to the x (FTTX), and switched digital video (SDV) networks that use different modulation schemes and multicasting techniques to deliver broadcast and interactive programming to consumers. Examples of the multicasting techniques include Internet protocol (IP) and asynchronous transfer mode (ATM). The broadcast overlay delivery network service providers use three different modulations schemes: quaternary phase shift keying (QPSK), quadrature amplitude modulation (QAM), and 8/16 vestigial sideband (VSB). An IDTV set that supports all three different modulation schemes used by broadcast providers and multicasting techniques used by SDV service providers would be difficult and costly to design.

### BRIEF DESCRIPTION OF THE DRAWINGS

The present invention is pointed out with particularity in the appended claims. However, features are described in the following detailed description in conjunction with the accompanying drawings in which:

FIG. 1 is a block diagram of an embodiment of a modular television set in accordance with the present invention;

FIG. 2 is a functional block diagram encompassing multiple embodiments of interactive network modules (INMs);

FIG. 3 is a functional block diagram of an embodiment of an INM for use with a cable delivery network;

FIG. 4 is a functional block diagram of an embodiment of an INM for use with a satellite delivery network;

FIG. 5 is a functional block diagram of an embodiment of an INM for use with a terrestrial broadcast delivery network; and

FIG. 6 is a functional block diagram of an embodiment of an INM for use with a switched digital video network.

### DETAILED DESCRIPTION OF THE DRAWINGS

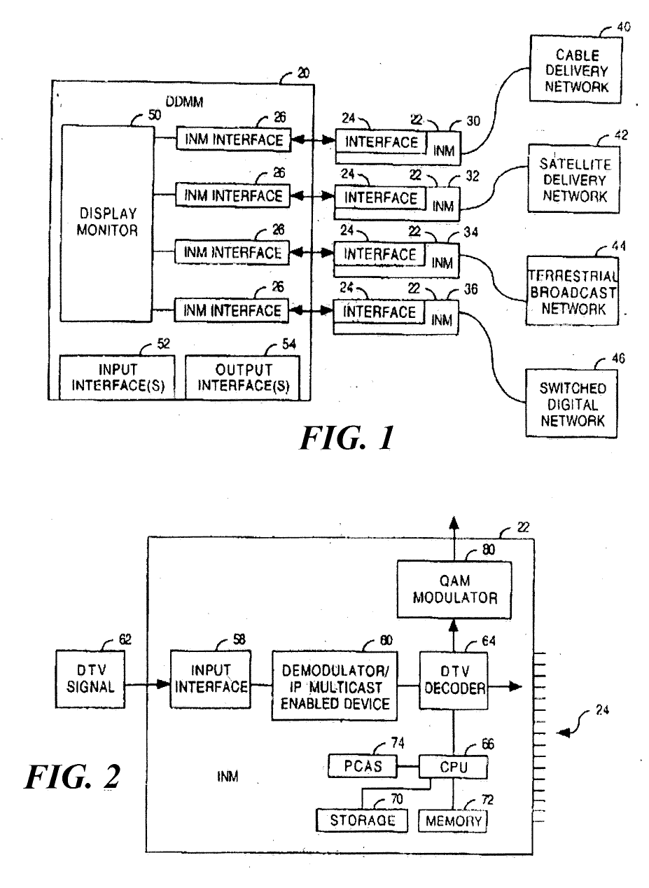

To address the above challenges in successfully making the migration to DTV, it is desirable to manufacture modular television sets that are flexible to upgrade, easy to use and connect to delivery networks, and do not require a set-top box to decode an incoming DTV video stream. FIG. 1 is a block diagram of an embodiment of a modular television set. The modular television set has a digital display monitor module (DDMM) 20 that is designed for long term use, such as 10 to 15 years, based on the current consumer replacement rate for television sets. The modular television set uses interactive network modules (INMs) 22 that can be easily upgraded and replaced by the user when required.

The INMs 22 have a common hardware interface 24 that is connected to a common standardized hardware interface 26 in the DDMM 20. The interface 24 comprises multiple electrical connection points that mate with multiple electrical connection points of the interface 26. The common standardized hardware interface 26 in the DDMM 20 allows one or more of the INMs 22 to be used with each digital television set. For example, four INMs 30, 32, 34 and 36 may be simultaneously interfaced with the DDMM 20. The INM 30 may support DTV from a cable delivery network 40. The INM 32 may support DTV from a direct broadcast satellite (DBS) delivery network 42. The INM 34 may support DTV from a terrestrial, over-the-air broadcast network 44. The INM 36 may support DTV from a switched digital video network 46.

Each of the INMs 22 may have the form of a printed circuit board in a thin enclosure that the user can independently plug into or otherwise install into the DDMM 20. Further, each of the INMs 22 can be independently removed from the DDMM 20 by the user. The multiple electrical connection points of the interface 24 can be disposed on an edge of the printed circuit board.

The DDMM 20 comprises a display monitor device 50 with one or more input interfaces 52 and one or more output interfaces 54 allowing other auxiliary audio/video devices such as video cassette recorders (VCRs), digital video disk (DVD) players, and cameras to be connected thereto. The display monitor device 50 may comprise a cathode ray tube (CRT), a liquid crystal display (LCD), a plasma display, or another display technology to display decoded digital video for view by users. The display monitor device 50 displays the video based on a decoded video signal generated by an INM.

It is envisioned that the DDMMs and the INMs which support terrestrial, over-the-air free DTV broadcasts, such as the INM 34, would be purchasable by consumers from retail stores. The other INMs also can be sold at the retail stores, either concurrent with or after the sale of a DDMM. Alternatively, cable, satellite and switched digital service provider companies can send the INMs to their subscribers upon signing up for service.

The user can replace an INM when, for example, a new video compression technology is available or new hardware is required to support new applications. This offers greater flexibility to service providers to offer new applications and services. Further, the modular television set handles multiple premium television services offered by cable and DBS television service providers in a seamless manner and without an additional set-top box.

FIG. 2 is a functional block diagram encompassing multiple embodiments of the INMs 22. The INM comprises an input interface 58 that receives an incoming DTV signal 62. A demodulator and/or an IP multicast-enabled device 60 processes the incoming DTV signal 62. If the DTV signal 62 is from a cable headend, a direct broadcast satellite (DBS) or an off-air signal, the device 60 is a demodulator to demodulate the DTV signal. If the DTV signal 62 is a multicast signal from a switched digital video network such as digital subscriber line (DSL), the device 60 is an IP multicast-enabled device to extract an incoming compressed video stream.

The INM 22 comprises a DTV decoder 64 that decompresses the compressed video stream from the demodulator and/or IP multicast-enabled device 60 in real-time. The DTV decoder 64 has modes to decode various DTV formats, such as HDTV and SDTV formats. Preferably, the DTV decoder 42 is capable of decoding signals that are interlaced (e.g. a 1920x1080i HD resolution signal) and progressive (e.g. a 1280x720p HD resolution signal). The DTV decoder 42 is also capable of decoding full resolution SD signals (e.g. a 720x480i resolution signal).

For currently-adopted standards, the DTV decoder 64 comprises a Moving Picture Group (MPEG) decoder 64 to decode data compressed based on an MPEG-based protocol. In one embodiment, the DTV decoder 64 is capable of decoding data compressed based on MPEG-2. The DTV decoder 64 may be flexible to enable decoding of at least two different versions of MPEG streams (e.g. at least two different versions of MPEG-2 streams).

As subsequent MPEG standards are deployed, the DTV decoder 64 may be based thereon to produce an INM with which the user can upgrade his/her television set. Further, the DTV decoder 64 may be based on a non-MPEG standard, such as H.264 AVC, to produce an INM with which the user can upgrade his/her television set.

The DTV decoder 64 sends a resulting decoded video signal to the interface 24. The decoded video signal is communicated from the interface 24 to the interface 26, and then to the display monitor device 50. The display monitor device 50 displays video based on the decoded video signal.

The INM 22 further comprises a central processing unit (CPU) 66, a storage device 70, and a memory 72 such as a random access memory (RAM), for management, control, content storage, personal video recording (PVR) functionality, and other value-added applications such as gaming and Web-enabled services. The storage device 70 may comprise a hard drive or an alternative re-writeable storage medium to provide PVR features.

The INM 22 further comprises a programmable conditional access system (PCAS) 74 that allows authorized users to have access to premium television services and content. Examples of the premium television services include, but are not limited to, pay-per-view, video-on-demand and interactive television services.

A television service provider can program the PCAS 74 with its own version of conditional access (CA) data and digital rights management (DRM) data. To program the PCAS 74, the television service provider can send its own specific CA and/or DRM data in signals to be received via the input interface 58.

To illustrate use of the PCAS 74, consider a first television service provider that provides a first premium television service and a second television service provider that provides a second premium television service. The first and second premium television service providers may be two different cable television service providers, two different direct broadcast satellite television service providers, or two switched digital video service providers, for example.

Consider the user initially subscribing to the first premium television service. In this case, the PCAS 74 provides a first version of CA and DRM to enable conditional access to the first premium television service. Thereafter, consider the user wishing to cancel his/her subscription to the first premium television service, and instead subscribe to the second premium television service. In this case, the second premium television service can program the PCAS 74 to store a second version of CA and DRM to replace the first version. The second version of CA and DRM enables conditional access to the second premium television service. Making the PCAS 74 programmable in this manner is beneficial when the user wants to change service providers (e.g. one cable provider to another cable provider, one DBS provider to another DBS provider, or one switched digital video service provider to another) to supply premium channels to the television.

Optionally, the INM 22 comprises a modulator 80, such as a QAM modulator, to modulate the output signal from the DTV decoder 64. The modulated signal can be broadcast to analog television sets through an in-home coaxial distribution network. A filter can be used to block the modulated signal from going to an outside distribution network, such as an HFC distribution network.

Using the modulator 80, the DTV television set of the present patent application can be used to provide one or more analog NTSC feeds to older, analog television sets in the user's home. To provide multiple different channels to multiple different analog TV sets, a plurality of DTV decoders and modulators are included in the INM 22. A wireless remote control can communicate with the INM 22 to perform channel changing functions. The INM 22 may also provide other interactive functionality to each analog TV set, such as PVR, Web access, and other value-added services and applications.

All of the aforementioned functional components of the INM 22 can be mounted to or otherwise supported by a single printed circuit board. The INM 22 may comprise a thin enclosure to house the aforementioned components and the printed circuit board, and to provide access to the interface 24.

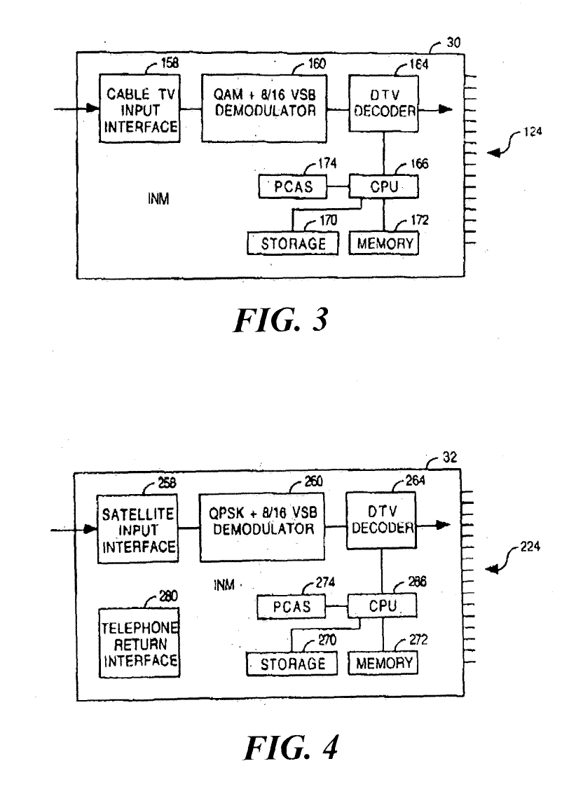

FIG. 3 is a functional block diagram of an embodiment of the INM 30 for use with the cable delivery network 40. The INM 30 comprises a cable television signal interface 158 such as a coaxial cable jack, for example. The cable television signal interface 158 is to receive television signals from a cable television source. The cable television source communicates the television signals from a cable head end to the user's television via a cable plant, such as an HFC network. The cable plant may also be used to communicate interactive television signals from the cable television signal interface 158 back to the cable television source.

A cable demodulator 160 is to demodulate television signals received via the cable television signal interface 158. The cable demodulator 160 may comprise a quadrature amplitude modulation (QAM) demodulator and/or a vestigial sideband (VSB) demodulator. The QAM demodulator may comprise a 64-QAM demodulator and/or a 256-QAM demodulator. The VSB demodulator may comprise an 8-VSB demodulator and/or a 16-VSB demodulator.

The INM 30 further comprises an interface 124, a DTV decoder 164, a central processing unit 166, a storage device 170, a memory 172 and a PCAS 174. Each of these components may be similar or the same as the interface 24, the DTV decoder 64, the central processing unit 66, the storage device 70 and the memory 72, respectively, described with reference to FIG. 2.

FIG. 4 is a functional block diagram of an embodiment of the INM 32 for use with the satellite delivery network 42. The INM 32 comprises a direct broadcast satellite interface 258 such as a coaxial cable jack, for example. The direct broadcast satellite television signal interface 258 is to receive television signals from a direct broadcast satellite source using an external antenna such as a dish antenna. Examples of the direct broadcast satellite source include those marketed under the Echostar™ brand and the DirecTV™ brand.

The direct broadcast satellite demodulator 260 is to demodulate television signals received via the direct broadcast satellite television signal interface 258. The direct broadcast satellite demodulator 260 may comprise a quaternary phase shift keying (QPSK) demodulator.

Preferably, the DTV decoder 264 is flexible to enable decoding of at least two different versions of MPEG streams (e.g. at least two different versions of MPEG-2 streams). For example, a standard version of MPEG-2 technology is specified for ATSC terrestrial broadcasting, digital cable transmission as specified by the Society for Cable Telecommunications Engineers (SCTE), and Echostar™'s direct broadcast satellite transmissions. However, a second version of MPEG-2, which differs slightly from the standard version, is used by DirecTV™. Thus, it is preferred that the DTV decoder 264 be capable of decoding Echostar™ and DirecTV™ versions of MPEG-2 streams.

To enable two-way communication with a DBS source, the INM 32 comprises a DBS telephone return interface 280, such as those implemented in conventional DBS set-top boxes.

The INM 32 further comprises an interface 224, a central processing unit 266, a storage device 270, a memory 272 and a PCAS 274, all of which may be similar or the same as the interface 24, the central processing unit 66, the storage device 70 and the memory 72, respectively, described with reference to FIG. 2.

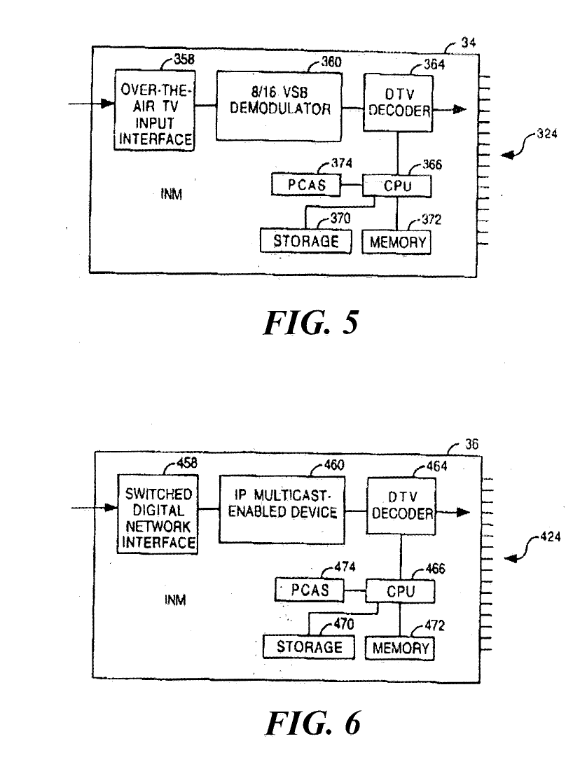

FIG. 5 is a functional block diagram of an embodiment of the INM 34 for use with the terrestrial broadcast delivery network 44. The INM 34 comprises an over-the-air television signal interface 358 such as a coaxial cable jack, for example. The over-the-air television signal interface 358 is to receive television signals from over-the-air sources using an external antenna. The over-the-air sources are terrestrial sources that broadcast local channels.

The over-the-air demodulator 360 is to demodulate television signals received via the over-the-air television signal interface 358. The over-the-air demodulator 360 may comprise an Advanced Television Systems Committee (ATSC) demodulator to demodulate 8-VSB or 16-VSB modulation signals used for terrestrial broadcasting in the United States.

The INM 34 further comprises an interface 324, a DTV decoder 364, a central processing unit 366, a storage device 370, a memory 372 and a PCAS 374, such as the interface 24, the DTV decoder 64, the central processing unit 66, the storage device 70 and the memory 72, respectively, described with reference to FIG. 2.

FIG. 6 is a functional block diagram of an embodiment of the INM 36 for use with the switched digital video network 46. The INM 36 comprises a switched digital video network interface 458 to receive video signals from a switched digital video network source. An IP multicast-enabled device 460 is to extract encoded video signals received by the switched digital video network interface 458.

The INM 36 further comprises an interface 424, a DTV decoder 464, a central processing unit 466, a storage device 470, a memory 472 and a PCAS 474, such as the interface 24, the DTV decoder 64, the central processing unit 66, the storage device 70 and the memory 72, respectively, described with reference to FIG. 2.

It will be apparent to those skilled in the art that the disclosed embodiments may be modified in numerous ways and may assume many embodiments other than the particular forms specifically set out and described herein.

Accordingly, the above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus comprising:
a digital display monitor module (DDMM) having a display device; and
an interactive network module (INM) that removably interfaces with the DDMM, the INM comprising an input interface and a programmable conditional access system (PCAS) to enable conditional access to at least one premium television service received by the input interface, wherein the PCAS is programmable by at least two different service providers.

2. The apparatus of claim 1 wherein the DDMM comprises a plurality of common INM interfaces, and wherein the INM interfaces with one of the common INM interfaces.

3. The apparatus of claim 1 wherein the INM comprises a demodulator to demodulate digital television signals, including the at least one premium television service, received by the input interface.

4. The apparatus of claim 3 wherein the demodulator comprises a cable television signal demodulator.

5. The apparatus of claim 4 wherein the cable television signal demodulator comprises a quadrature amplitude modulation (QAM) demodulator.

6. The apparatus of claim 4 wherein the cable television signal demodulator comprises a vestigial sideband (VSB) demodulator.

7. The apparatus of claim 3 wherein the demodulator comprises a direct broadcast satellite signal demodulator.

8. The apparatus of claim 7 wherein the direct broadcast satellite signal demodulator comprises a quaternary phase shift keying (QPSK) demodulator.

9. The apparatus of claim 7 wherein the direct broadcast satellite signal demodulator comprises a vestigial sideband (VSB) demodulator.

10. The apparatus of claim 3 further comprising a digital television decoder to decode demodulated digital television signals from the demodulator.

11. The apparatus of claim 10 wherein the digital television decoder comprises an MPEG decoder.

12. The apparatus of claim 11 wherein the MPEG decoder comprises an MPEG-2 decoder.

13. The apparatus of claim 10 wherein the digital television decoder comprises an H.264 AVC decoder.

14. The apparatus of claim 10 wherein the INM further comprises a modulator to modulate decoded digital television signals from the digital television decoder into an analog, NTSC format.

15. The apparatus of claim 14 wherein the modulator comprises a quadrature amplitude modulation (QAM) modulator.

16. The apparatus of claim 1 wherein the INM comprises a multicast-enabled device to extract digital television signals, including the at least one premium television service, received by the input interface.

17. The apparatus of claim 1 wherein the INM further comprises a storage device to provide a personal video recording feature.

18. The apparatus of claim 1 wherein the PCAS provides digital rights management programmable by the at least two different service providers.

19. The apparatus of claim 1 wherein the input interface comprises a cable television signal interface, and wherein the at least two different service providers comprise at least two different cable television service providers.

20. The apparatus of claim 1 wherein the input interface comprises a direct broadcast satellite signal interface, and wherein the at least two different service providers comprise at least two different direct broadcast satellite service providers.

21. The apparatus of claim 1 wherein the input interface comprises a digital switched video network interface, and wherein the at least two different service providers comprise at least two different digital switched video network service providers.

22. The apparatus of claim 1 wherein the PCAS is programmable via the input interface.

23. An interactive network module (INM) that removably interfaces with a digital display monitor module (DDMM) having a display device, the INM comprising:
a cable television signal interface;
a demodulator to demodulate digital television signals, including a premium television service, received by the cable television signal interface, the demodulator comprising a quadrature amplitude modulation (QAM) demodulator and a vestigial sideband (VSB) demodulator; and
a programmable conditional access system (PCAS) to enable conditional access to the premium television service received by the cable television signal interface, wherein the PCAS is programmable by at least two different cable television service providers via the cable television signal interface.

24. An interactive network module (INM) that removably interfaces with a digital display monitor module (DDMM) having a display device, the INM comprising:
a direct broadcast satellite television signal interface;
a demodulator to demodulate digital television signals, including a premium television service, received by the direct broadcast satellite television signal interface, the demodulator comprising a quaternary phase shift keying (QPSK) demodulator and a vestigial sideband (VSB) demodulator; and
a programmable conditional access system (PCAS) to enable conditional access to the premium television service received by the direct broadcast satellite signal interface, wherein the PCAS is programmable by at least two different direct broadcast satellite service providers.

25. An interactive network module (INM) that removably interfaces with a digital display monitor module (DDMM) having a display device, the INM comprising:
a digital switched video network interface;
a multicast-enabled device to extract digital television signals, including a premium television service, received by the digital switched video network interface; and
a programmable conditional access system (PCAS) to enable conditional access to the premium television service received by the digital switched video network interface, wherein the PCAS is programmable by at least two different digital switched video network service providers via the digital switched video network interface.
